(19) United States
(12) Patent Application Publication
(10) Pub. No.: US 2025/0027216 A1
(43) Pub. Date: Jan. 23, 2025

(54) ELECTROLYZER

(71) Applicant: Frederic DERFLER, Haifa (IL)

(72) Inventor: Frederic DERFLER, Haifa (IL)

(21) Appl. No.: 18/715,675

(22) PCT Filed: Nov. 23, 2022
(86) PCT No.: PCT/IL2022/051251

§ 371 Date: May 31, 2024

Related U.S. Application Data
(60) Provisional application No. 63/286,052, filed on Dec. 5, 2021.

(51) Int. Cl. C25B 11/036; C25B 11/032; H01M 8/0656

(52) U.S. Cl. CPC C25B 11/036; C25B 11/032; H01M 8/0656

(57) ABSTRACT

A dome-shaped bipolar plate.

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

Electrolysis is a technique that uses direct electric current (DC) to drive an otherwise non-spontaneous chemical reaction. Such electrical current may be derived from energy sources such as solar panels and wind turbines. An electrolyzer operates by applying a voltage across two electrodes separated by an electrolyte, medium containing ions that is electrically conducting through the movement of those ions.

One type of electrolysis is hydrolysis, during which water is decomposed into oxygen and hydrogen. Hydrogen is an energy source that has high energy density and can be used to produce energy in a completely clean process and is also essential in many synthetic reactions.

Steam methane reforming (SMR) is a process in which methane from natural gas is heated, with steam, usually with a catalyst, to produce a mixture of carbon monoxide and hydrogen used in organic synthesis and as a fuel.

Carbon monoxide is a highly toxic gas and is also thought to contribute to global warming. Nevertheless, SMR is currently the most widely used process for the generation of hydrogen since the process is much cheaper than producing hydrogen by electrolysis.

### SUMMARY

It may be desirable to provide improved systems and methods for producing gas that are environmentally friendly and safe, which for example have an improved efficiency. Such systems and methods are for example respectively improved electrolyzers and electrolysis, and fuel cells and other electrochemical cells.

Described herein are devices, systems, and methods for electrolysis to overcome the pre-existing challenges and achieve the benefits as described herein.

Electrolyzer cells and fuel cells may include bipolar plates, electrodes, a diaphragm or membrane, mesh, gas diffuser layer (GDL)and gaskets.

In each cell the bipolar plates hold between them the other components.

Bipolar plates are designed to simultaneously perform a number of critical functions in a fuel cell stack to ensure acceptable levels of power output and a long stack lifetime:

The bipolar plates collect and transport electrons from the anode to cathode.

They connect individual cells in series to form a cell stack of the required voltage.

They separate gases such as hydrogen and oxygen, while removing water and unreacted gases and other materials. Hence, they are impermeable to gases.

They can contain gas flow field channels or can be flat and the flow will be only in a mesh layer, thereby providing a flow path for gas and water transport to uniformly distribute the gases and water over the entire electrode areas.

They provide structural support for the fuel cell stack.

The bipolar plate accounts for more than 40% of the total stack cost and about 80% of the total weight.

Recently there has been significant research and development to lower their cost, reduce their size, and improve their performance and lifetime.

According to one aspect, a dome-shaped bipolar plate is provided.

In some embodiments the bipolar plate comprises a plate rim, the plate rim comprising anode reaction outlets and cathode reaction outlets.
In some embodiments the bipolar plate further comprises a plate center, and reactant inlets extending throughout the center.
In some embodiments the bipolar plate has a thickness of from about 0.2 mm up to about 1 mm.

According to another aspect an electrolyzer is provided, the electrolyzer comprising: a stack of dome-shaped bipolar plates.

In some embodiments each plate in the electrolyzer comprises: a plate rim and a plurality of anode reaction outlets and cathode reaction outlets on the rim;
wherein:
the anode reaction outlets are aligned therethrough the stack and cathode reaction outlets are aligned therethrough the stack.

In some preferred embodiments the electrolyzer further comprises at least one of a group consisting of: dome-shaped mesh, dome-shaped GDL, dome-shaped diaphragm or membrane (MEA), dome-shaped current collector, and dome-shaped end plates. In some preferred embodiments, a plurality of one of more of said group members are present in the electrolyzer.

In some electrolyzer embodiments each plate comprises a plurality of anode channels on an anode side of the plate and a plurality of cathode channels on a cathode side of the plate, wherein each anode channel overlaps a plurality of cathode channels and each cathode channel overlaps a plurality of anode channels.

In some electrolyzer embodiments each bipolar plate further comprises holes that allow elastomeric gasket material to pass from one side to the other of the plate during an injection over molding process performed on the plate.

In some preferred electrolyzer embodiments the stack further comprises end plates having a thickness from about 20 mm to about 200 mm.

According to yet another aspect an electrolysis system is provided, the system comprising:
an electrolyzer comprising a stack of dome-shaped bipolar plates, and a storage system comprising a tank containing the stack. The system is configured to allow controlling storage of gaseous hydrolysis products from electrolysis in the stack.

According to another aspect, a method of producing a dome-shaped bipolar plate is provided, the method selected from: vacuum forming and stamping.

According to yet another aspect, a method of producing a stack is provided, the method comprising: producing a plurality of dome-shaped bipolar plates by vacuum forming and stamping, and producing a plurality of dome-shaped meshes by stamping, and/or dome-shaped GDLs by stamping.

According to another aspect, a method of producing hydrolysis products is provided, the method comprising:
providing an electrolyzer comprising a stack of dome-shaped bipolar plates; each plate comprising: a plate rim and a plurality of anode reaction outlets and cathode reaction outlets on the rim;
   wherein:
   the anode reaction outlets are aligned therethrough the stack and cathode reaction outlets are aligned therethrough the stack;
   holding up the stack;
   feeding water to the stack;
   performing hydrolysis on the water fed to the stack;
   allowing products of hydrolysis on the plate cathodic side and on the plate anodic side to be separated from each other and float in a continuum up the stack through the outlets.

According to another aspect, a method of producing electrolysis products is provided, the method comprising:
providing an electrolyzer comprising a stack of dome-shaped bipolar plates; each plate comprising: a plurality of anode channels on an anode side of the plate and a plurality of cathode channels on a cathode side of the plate, wherein each anode channel overlaps a plurality of cathode channels and each cathode channel overlaps a plurality of anode channels;
   feeding water to the stack;
   performing hydrolysis on the water fed to the stack;
   allowing products of hydrolysis on the plate cathodic side and on the plate anodic side to be separated from each other;
   further providing a storage system comprising a tank containing the stack, and
   controlling storage of gaseous hydrolysis products in the tank from electrolysis in the stack.

In some method embodiments the gaseous hydrolysis products in the tank are essentially hydrogen.

### Terminology

Dome-shaped: a structure having a three-dimensional shape which can be created by intersection of a plane with a sphere or an ellipsoid. The dome may be a hemisphere or hemiellipsoid but in general the dome may be less than a hemisphere.

It should be appreciated that all combinations of the foregoing concepts and additional concepts discussed in greater detail below (provided such concepts are not mutually inconsistent) are contemplated as being part of the inventive subject matter disclosed herein and to achieve the benefits/advantages as described herein. In particular, all combinations of claimed subject matter appearing above and/or at the end of this disclosure are contemplated as being part of the inventive subject matter disclosed herein.

### BRIEF DESCRIPTION OF THE DRAWINGS

The details of one or more implementations are set forth in the accompanying drawings and the description below. Other features, aspects, and advantages will become apparent from the description, the drawings, and the claims, in which:

FIG. 1a schematically depicts a prior art alkaline electrolyzer;

FIG. 1b schematically depicts a prior art anion exchange membrane electrolyzer;

FIG. 1c schematically depicts a prior art proton membrane electrolyzer;

FIG. 2a illustrates a prior art electrolyzer that includes a stack of electrolysis cells;

FIG. 2b shows a vertical cross-section of one electrolysis cell in the prior art stack;

FIG. 2c illustrates a prior art qualitative comparison of the energy losses based on reaction resistances in electrolysis;

FIG. 2d illustrates the effect of various parameters on the efficiency of the electrolysis process;

FIG. 3a illustrates a schematic drawing of a cross-section of a stack that includes dome-shaped cells;

FIG. 3b schematically illustrates in perspective view a cross-section of a cell that includes a bipolar plate;

FIG. 4 shows a vertically positioned stack;

FIG. 5 depicts a cross section of adjacent bipolar plates and a diaphragm or membrane and optionally a gasket in between;

FIG. 6a depicts an exploded partial view of a stack embodiment;

FIG. 6b shows an exploded partial view of a larger part of the stack;

FIG. 7a illustrates assembly of a MEA (membrane electrode assembly) and a stack;

FIG. 7b further illustrates assembly of the MEA on a stack;

FIGS. 8a, 8b illustrate displacement and stress tests, respectively on a hemispherical plate, and

FIGS. 8c, 8d illustrate displacement and stress tests, respectively for a flat plate.

FIG. 9 schematically depicts another stack embodiment;

FIG. 10a depicts a bipolar plate for the stack illustrated in FIG. 9, from an anode side;

FIG. 10b depicts the bipolar plate for the stack illustrated in FIG. 10, from a cathode side;

FIG. 10c shows the bipolar plate depicted in FIGS. 10a, 10b wherein the diaphragm is made transparent to show both sides at once;

FIG. 11 further depicts flow of reactants and products through the stack shown in FIG. 9, in a sectional perspective view;

FIG. 12 shows a storage system that may be used to control the storage of the hydrogen gas produced in a stack such as shown in FIG. 9, and

FIG. 13 illustrates yet another embodiment of a bipolar plate for a stack.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

### Introduction

In some aspects, methods and systems are disclosed herein for promoting environmentally friendly, efficient electrolysis.

Electrolyzers are expected to be core technologies in a renewable energy future because of their ability to electrolyse water, i.e., use electricity, e.g., from solar photovoltaics or wind, to convert water to hydrogen (H₂). As such, it may be used for example for storage of excess energy produced during the daytime with photovoltaics, and energy withdrawal in the dark hours of the day.

(H₂) is an energy-dense fuel, which can be stored for long periods of time and may be more cost effective and more energy-dense than storage of energy in batteries.

Hydrogen in today's market is produced in general via the steam methane reforming (SMR) reaction, a process which relies on fossil fuels and releases carbon monoxide and a small amount of carbon dioxide (CO₂) which is an environmentally unfriendly process. However, today there is already a large market for hydrogen production also with electrolyzers, despite the higher production price

Although electrolysis of water is an environmentally friendly process, at present it is much less energy efficient than SMR due several shortcomings in the presently known electrolysis processes. Energy efficiency is the ratio between the energy received when burning one mole of hydrogen and the energy needed to produce one mole of hydrogen. The working efficiency of an electrolyzer cell depends on many parameters. In particular, because of the inherent constraints associated with the currently known architecture and materials, the conventional alkaline water electrolyzer and the emerging proton exchange membrane electrolyzer [described below] are suffering from low efficiency and high materials/operation costs, respectively.

Our aim is to remove or reduce some of these shortcomings and thus make water electrolysis more energy efficient.

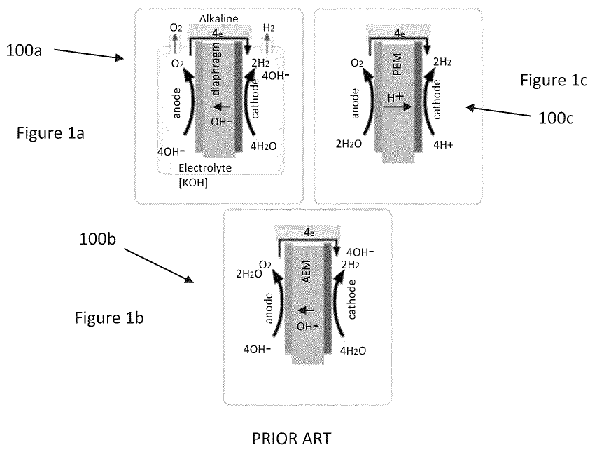

FIGS. 1a-1c schematically depict various commercially available prior art electrolyzers. Each electrolyzer includes a cathode, an anode, and an electrolyte.

The alkaline electrolyzer 100a shown in FIG. 1a includes a diaphragm in between the anode and the cathode. The electrolyte includes an aqueous solution containing hydroxyl (dissolved KOH). Hydroxyl anions are oxidized at the anode to water and oxygen, and water is reduced at the cathode to hydroxyl anions and hydrogen. The diaphragm is selective to allow flow of OH⁻ from a cathode surface to an anode surface. Oxygen and hydrogen are removed during the process as bubbles that exit the electrolyte as gas.

The anion exchange membrane electrolyzer 100b shown in FIG. 1b includes an anion exchange membrane (AEM) in between the anode and the cathode. Here too hydroxyl anions are oxidized at the anode to water and oxygen, and water is reduced at the cathode to hydroxyl anions and hydrogen. The AEM is also selective to allow flow of hydroxyl from a cathode surface to an anode surface. Oxygen and hydrogen are removed during the process as bubbles that exit the electrolyte as gas.

The proton exchange electrolyzer 100c shown in FIG. 1c includes a proton exchange membrane (PEM) in between the anode and the cathode. Here the electrolyte is water. Water rather than hydroxyl is oxidized at the anode, to hydronium and oxygen. The PEM selectively allows the hydronium ions to pass from the anode surface to the cathode surface, and the hydronium ions are reduced at the cathode to hydrogen. The PEM is also selective to allow flow of hydroxyl from a cathode surface to an anode surface. Oxygen and hydrogen are removed during the process as bubbles that exit the electrolyte as gas.

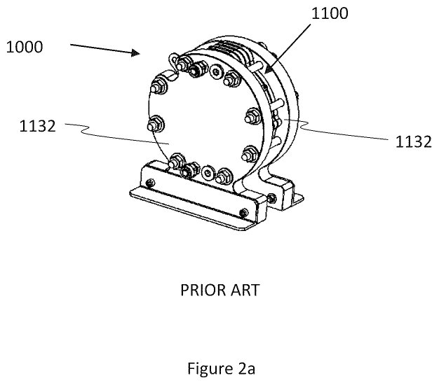

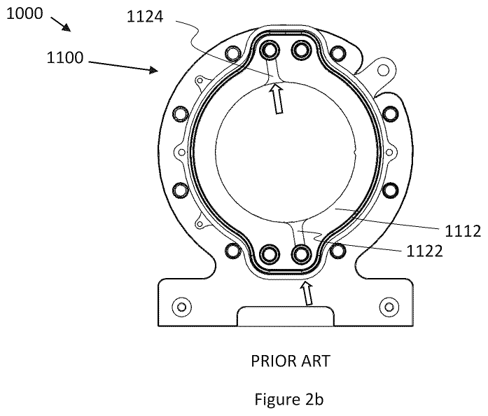

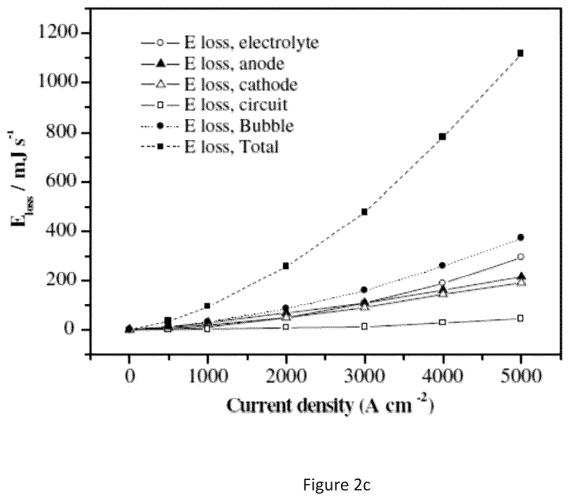

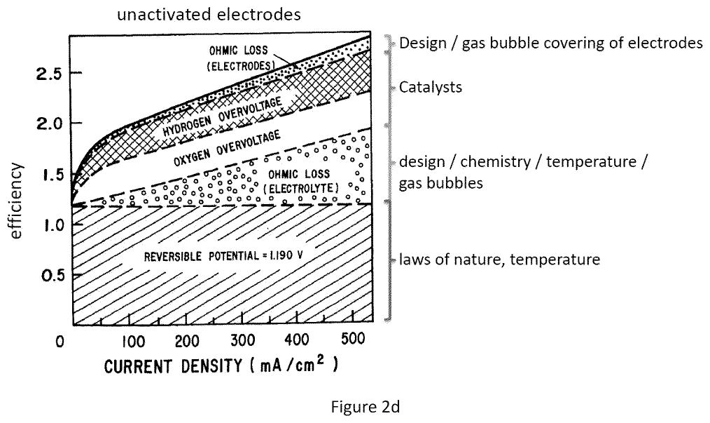

FIG. 2a illustrates a prior art electrolyzer stack 1000. The stack 1000 is made of multiple electrolysis cells 1100. The stacking allows increasing the production rate.

FIG. 2b shows a vertical cross-section of one flat electrolysis cell 1100 in the stack 1000. The cell 1100 has a circular profile, which imparts mechanical strength to the cell 1100 to withstand pressures from gases that accumulate in the cell 1100 during electrolysis. The white arrows show the ingress through the entrance 1122 and departure via the exit 1124 respectively of reactants and products into and from the cell 1100. At first, as the reactants enter the cell 1100, the active area of the electrode 1112 that is exposed to the reactants (electrolyte) increases from the entrance 1122 towards the exit 1124, allowing for an increased reaction. However, since the electrode 1122 has a round profile, the active surface area eventually decreases as the reactant approaches the exit 1124. Moreover, bubbles accumulate proximal to the bottleneck exit 1124, due to the increasing restriction of the geometry of the electrodes. A large density of attached bubbles can interfere with the rate of disengagement of further bubbles.

Wherever bubbles adhere to the electrode's surfaces there is also no local current, thus reducing the overall current of the cell. The reduction of the current directly reduces the rate of the manufacture of new bubbles.

FIG. 2c illustrates a qualitative comparison of the energy losses based by reaction resistances in electrolysis: ohmic resistance, ionic resistance, and bubble resistance. The figure indicates that that the resistance of the bubbles causes the biggest energy loss of all energy losses in the process.

FIG. 2d illustrates the effect of various parameters on the efficiency of the electrolysis process. Electrical resistance causes wastage of electrical energy as heat. Note that the bubbles have a double detrimental effect on the efficiency.

Therefore, the efficiency of such stack 1000 is severely limited by the accumulation of bubbles on the electrodes. Note from FIG. 2a that the cells 1100 are essentially disc shaped. Massive endplates 1132 are required to support the high pressure in the cells 1100.

### Major Features

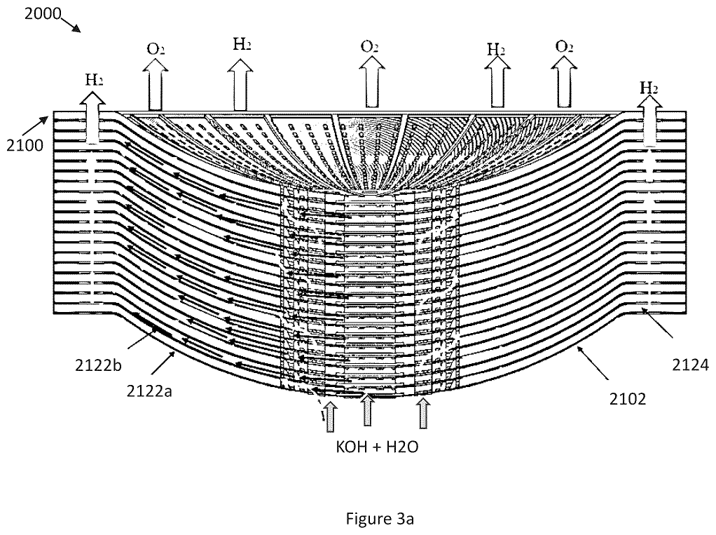

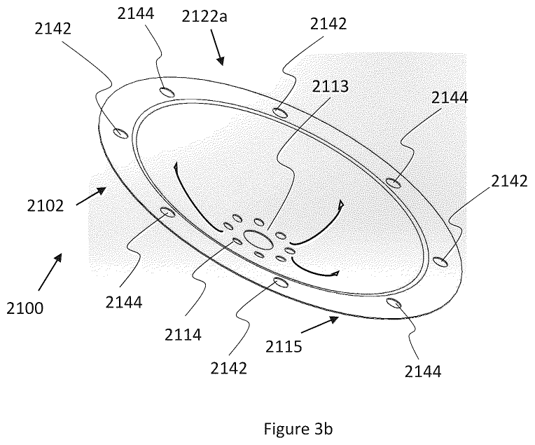

FIG. 3a schematically illustrates a cross-section of a stack 2000 that includes dome-shaped cells 2100. Some components of this stack 2000 embodiment are not shown for the sake of clarity and to allow to focus on the parts described immediately below.

FIG. 3b illustrates in perspective view a bipolar plate 2102 of a cell 2100.

As shown in FIGS. 3a-3b and explained below, the stack 2000 comprises:
dome-shaped bipolar plates 2102;

each plate 2102 comprising: a plate centre 2113, a plate rim 2115, a plate cathode side 2122a, a plate anode side 2122b, and a plurality of anode reaction outlets 2142 and cathode reaction outlets 2144 on the plate rim 2015;

a plurality of reactant inlets 2114 extending throughout the centre 2113 of each plate 2102.

Anode reaction outlets 2142 are aligned therethrough the stack 2000 and cathode reaction outlets 2144 are aligned therethrough the stack 2000. In other words, products of hydrolysis on the plate cathodic side 2122a and on the plate anodic side 2122b are separated from each other and float in a continuum up the stack 2000 through the outlets 2142, 2144.

The radial flow gives equal, good and homogeneous coverage of the electrodes.

Each stack may further comprise dome-shaped diaphragms, or membrane, each one disposed between each cathode side of one plate and anode side of an adjacent plate.

In some embodiments a at least one separator such as a diaphragm is provided that has a domed shape essentially matching the bipolar plates' shapes, typically with a thickness of up to about 0.5 mm. An example of a diaphragm material is zirfon (polysulfone matrix and zirconia which is present as a powder).

Returning now to the bipolar plates, the dome shape of the plates 2102 provides increasing reactive area of both the plate cathodic side 2122a and the plate anodic side 2122b, going from the plate centre 2113 towards the plate rim 2115. Therefore, bubbles created near the plate centre 2113 minimally accumulate and minimally impede flow of current through the stack 2000. Increasing the area downstream increases the amount of bubble. There are more bubbles, but also more surface area so that there is no disruption to the process of bubble disengagement or evacuation of the gas. Increasing the area with the flow also facilitates transport of the ions. Thus, the electrolysis can be very greatly more efficient compared to known hydrolyzers. The energy losses due to the resistance of the process will be smaller because the resistance of the bubbles will be smaller. For example, hydrolysis to produce hydrogen gas can be first made comparable in cost to production of hydrogen by SMR.

According to another aspect, an electrolysis process is provided, the process comprising:
a) providing an electrolyzer as described above;
b) passing reactant via the reactant inlet;
c) passing current via each plate, thereby electrolysing the reactant into anode product/s and cathode product/s, wherein at least one of the anode product/s and/or cathode products are gas; wherein each plate is oriented such that gas bubbles created during the electrolysis float along the channels from the center towards the rim; and
d) collecting gas floating through the anode reaction outlets and/or collecting gas floating through the cathode reaction outlets.

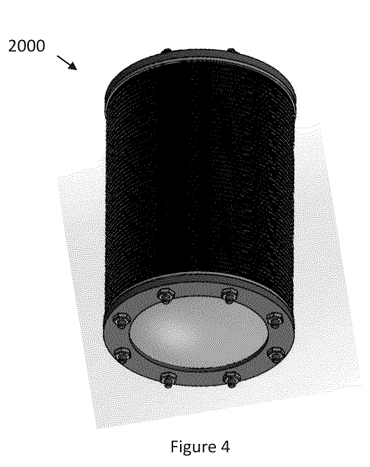

The stack 2000 may be vertically positioned like the illustration in FIG. 4. The vertical orientation serves two purposes: a) minimum floor space is required for the stack 2000 b) the gasses produced during the electrolysis naturally have a buoyancy which is in a direction perpendicular to the floor upon which the stack 2000 is placed, therefore the bubbles passing over the plates 2102 are naturally forced towards the rim 2115 and the anode reaction outlets 2142 and cathode reaction outlets 2144.

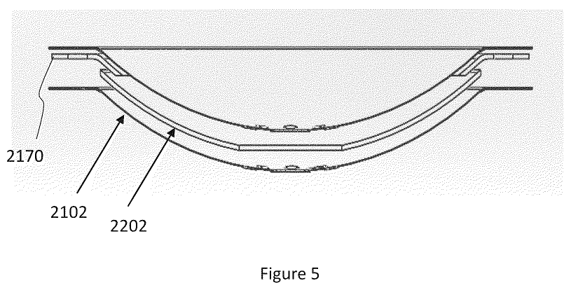

FIG. 5 depicts a partial view of a cross section of bipolar plates 2102 and a diaphragm or membrane 2202 therebetween.

The lower side of the diaphragm or membrane 2202 where hydrogen is present is proximal to where a cathode resides and the upper side of the diaphragm or membrane where oxygen is present is proximal to where an anode resides.

A stream of liquid entering a bipolar plate from underneath via the plate centre may be divided in a manifold into a first stream directed towards an anode and a second stream directed towards a cathode. This manifold may be situated inside plug/s in the reactant inlet/s.

The manifold and/or plug may have a dome shape. The manifold/plug can be made of an elastomer, preferably inert to chemical/electrochemical attack/heat and current (for example EPDM). In some embodiments liquid entering the manifold at first flow rate and pressure will be diverted to the anode and at second flow rate and pressure will be diverted to the cathode.

Liquid leaving the cathode surface together with hydrogen may be completely separated from liquid leaving the anode surface together with oxygen, by means of an exit manifold, again which may be dome-shaped and may include channels associated with either the anode or the cathode—hydrogen will go via cathode channels to cathode reaction outlets, and oxygen will go via anode channels to anode reaction outlets.

FIG. 5 also shows a gasket 2170 between the plates 2102. The gasket 2170 can be positioned under a plate lid 2115 and over a porous diaphragm or membrane 2202, to create a space along which the gas can flow and isolate the plate cathodic side 2122a from the plate anodic side 2122b.

A skilled in the art will appreciate that the gaskets should be carefully designed to conform with the entrance and exit manifolds in order to obtain a good seal between the bipolar plates and the diaphragms or membrane, and between the inlets of the anodes and the inlets of the cathodes, as well as between each cell and the surrounding area. Such seal is essential for achievement of a high yield and also for safety in preventing an explosion from the contact of hydrogen with oxygen.

Such electrolytic stacks can build up very high internal pressures; therefore, in commercially available electrolytic stacks massive end plates 1132 are used. However, due to the unique structure of our plates 2102, as another surprising advantage, the end plates may not need to be so massive, as the dome structure increases the strength of the stack 2000: The bipolar plates' domed shape may drastically increase the moment of inertia. The unique shape may make it possible to significantly lower the thickness of the end plates and of the bipolar plates, which minimizes or at least lowers the weight of the stack and increases the stability of the stack. The shape may also allow for easier assembly and easier disassembly that allows in turn for easier maintenance. The shape may also help reduce the diameter of the stack, which reduces the normal forces that are applied to the stack and thus reduces the required diameter of the clamping screws.

In some embodiments the bipolar plates are thinner than prior art plates used for electrolysis thanks to their increased strength, thus considerably saving material for construction of the stacks. Such thinner plates may also be relatively easily manufactured by processes such as, vacuum forming or stamping which cannot be used for thick plates.

The embodiments described herein provide novel mechanical solutions that significantly improve the efficiency of electrolyzers, and the physical attributes of stacks such as in respect of weight, floor space requirements, and stability. In effect, a heretofore two-dimensional system is now provided as an improved three-dimensional system.

As a result of the domelike structure of the plates the electrolyte flows in a radial spreading form in three dimensions, therefore the active area for electrochemical reactions steadily increases towards product outlets. The form also facilitates separation of the gases as explained above.

The system can be used for example for hydrolysis, wherein the amount of hydrogen and oxygen bubbles can steadily be increased as the electrolyte spreads, without increasing their density. This radial flow increases the current density.

The system shown in FIGS. 3a-5 is based on novel AEM cells. Movement of ions from the cathodic side of the plates to the anodic side in alkaline cells is unhindered. Similarly, in PEM systems ions can freely move from the anodic side to the cathodic side. However, the system is also suitable for use for alkaline hydrolysis. These are currently considered as best modes. A solid oxide system is currently thought to be less suitable for the use due the high temperature required to operate.

In stacks with such selective separation between the anode and the cathode, on the side of the cathode the generation of bubbles can be minimized, and the hydrogen molecules movement towards the exit from the stack is facilitated.

### Features in Embodiments and Additional Details

The bipolar plates may be made of any materials known to be effective in the desired reaction.

For example, for hydrolysis the plates may comprise stainless steel, for example alloy SS316. The SS316 may be plated, for example with nickel.

As explained and shown in the embodiment described above, cells in some embodiments comprise membranes/separators 2124 that may comprise PEM or AEM.

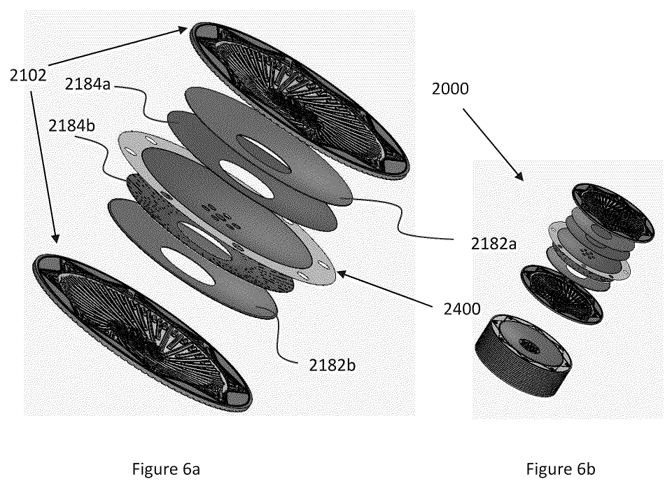

FIG. 6a depicts an exploded partial view of stack embodiment 2000, with two of the bipolar plates 2102 shown. FIG. 6b shows a larger part of the stack 2000.

An additional component shown is an MEA therebetween.

A membrane electrode assembly (MEA) is typically an assembled stack of proton-exchange membranes (PEM) or anion exchange membranes (AEM), catalysts and electrodes used in fuel cells and electrolyzers.

However, in some other embodiments, e.g., those based on an alkaline electrolyzer, there is no membrane.

Further components between adjacent bipolar plates 2101 are a cathode-side mesh 2182a, a cathode side gdl/nickel foam 2184a, an anode-side mesh 2184b, and an anode side gdl/nickel foam 2184b. These components are optional and may be replaced with other components with similar functionality.

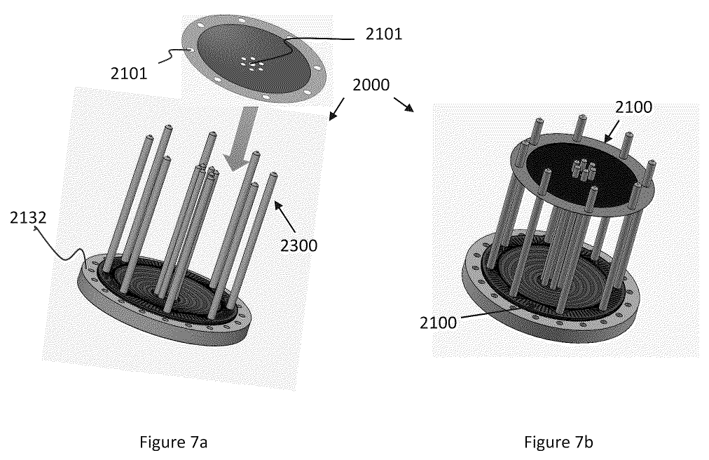

GDL (Gas Diffusion Layer) is a key component in various types of fuel cells, including Proton Exchange Membrane (PEM), Direct Methanol (DMFC) and Phosphoric Acid (PAFC) stacks as well as in other electrochemical devices such as electrolyzers. In fuel cells, this thin, porous sheet must provide high electrical and thermal conductivity and chemical/corrosion resistance, in addition to controlling the proper flow of reactant gases (hydrogen and air) and managing the water transport out of the membrane electrode assembly (MEA). As shown in FIGS. 7a, 7b the assembly of the MEA 2200 (in a wet state) inside the stack 2000 can be done with the help of guides 2300. Closing the cell, the MEA 2200 will easily take the hemispherical form. An end plate 2132 and guides 2300 may first be constructed and assembled together, with the guides 2300 extending from the end plate 2132 in a direction normal to the end-plate's face as illustrated in FIG. 7a. The guides 2300 may be attached to the endplate 2132 in an arrangement such that holes 2201 in the MEA are aligned with the guides' 2300 arrangement, so that the MEA 2200 is easily slid onto a cell 2100.

The production of the membrane may be performed with a cutting press. The resulting product will be flat but will assume a dome shape like that of the bipolar plates upon being installed in the stack.

The mesh 2128a, 2128b can be produced from a template, for example by a stamping process from a flat disc-shaped article of nickel foam. However, in some embodiments the template is wavy in order to provide maximum surface area. After stamping and placing inside the stack these waves are mostly eliminated, however on a microscopic level they remain and still contribute to the efficiency of the hydrolysis.

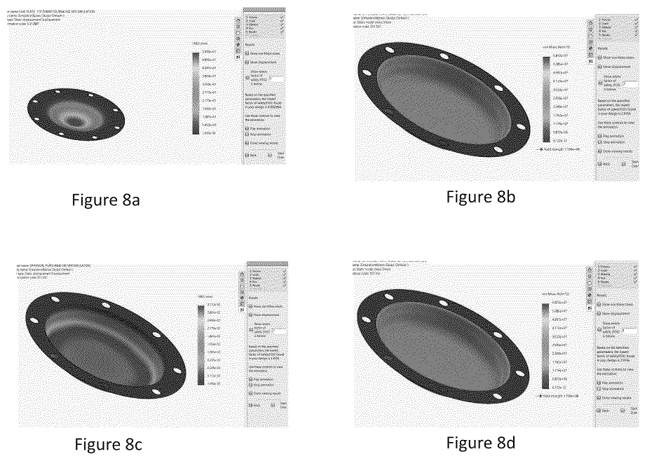

To help appreciate the huge advantage of our novel dome-shaped bipolar plates: an analysis of plates with an active area of 140 cm² and a thickness of 0.2 mm shows that for an equal pressure of 30 bars on the plates, a flat disc deforms 54 mm and tears whereas the dome-shaped/hemispherical disc only deforms 0.03 mm and does not tear. See simulation test results on a prior art flat plate, FIGS. 8a, 8b (displacement and stress tests, respectively), and on a hemispherical plate, FIGS. 8c, 8d (displacement and stress tests, respectively).

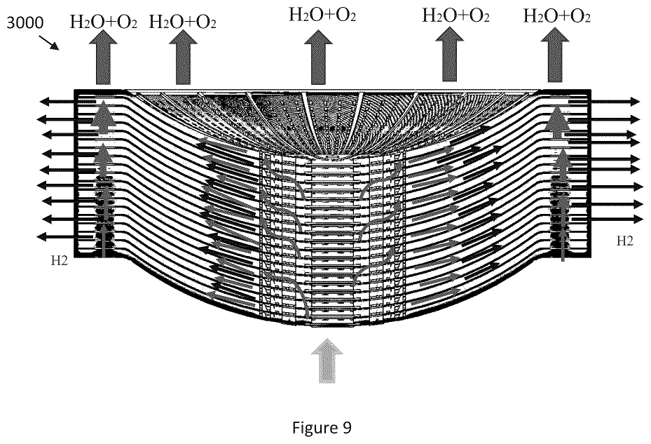

FIG. 9 schematically depicts another stack embodiment 3000. In this embodiment the hydrogen gas is released from the stack in a direction perpendicular to the direction of the flow of the reactants through the stack 3000.

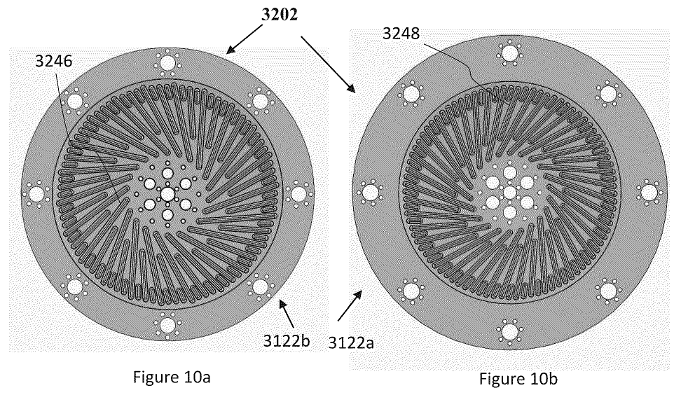

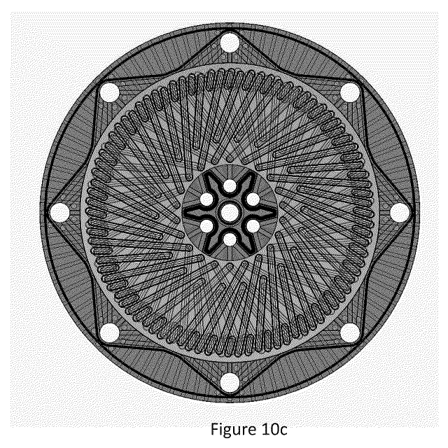

FIGS. 10a, 10b depict a-bipolar plate 3202 for a stack 3000 from an anode side 3122b and a cathode side 3122a. Each diaphragm 3202 comprises anode channels 3246 and cathode channels 3248.

In this arrangement the channels 3246, 3248 are oblique as shown, i.e., if a line is drawn to extend the channels to a point on the circumference of the plate, then the line is not perpendicular to a tangent line passing through that point.

FIG. 10c shows the bipolar plate depicted in FIGS. 10a, 10b wherein the-bipolar plate is made transparent to show both sides at once.

Each anode channel overlaps a plurality of cathode channels, and each cathode channel overlaps a plurality of anode channels.

This arrangement may offer several advantages to the operation and quality of the stack: The channels 3246, 3248 are somewhat longer than “straight” channels; the flow of hydrogen and oxygen is in different directions, thus better separating them; and the structural strength of the stack is improved by the channels 3246, 3248 crossing each other rather than overlapping each other.

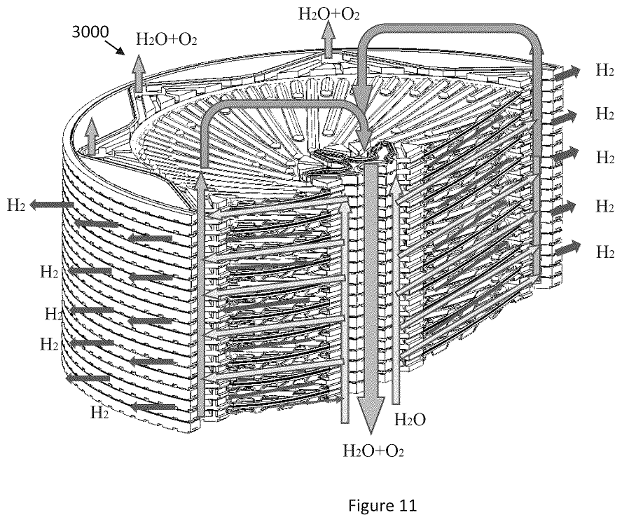

FIG. 11 further depicts flow of reactants and products through the stack 3000 in a sectional perspective view. Water (H₂O) flows from a water tank (not shown) into the stack 3000; water and oxygen (O₂) horizontally flow via an anode side of each cell, up through the stack 3000 and then back to the water tank. Hydrogen (H₂) horizontally flows via a cathode side of each cell and then exits the stack.

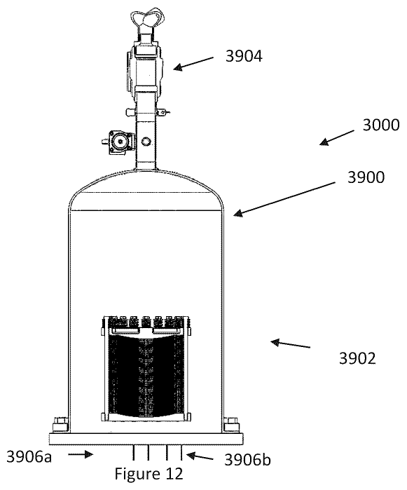

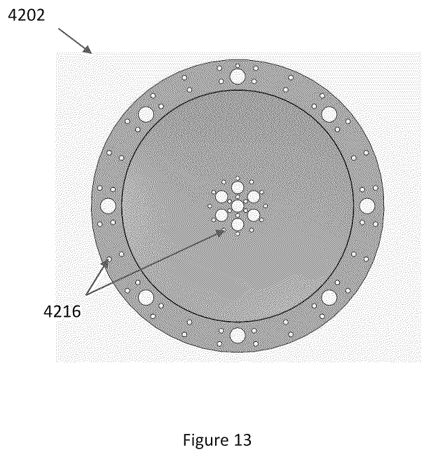

As schematically illustrated in FIG. 12, when a stack is used that is configured to allow hydrogen to immediately exit the stack as in the stack 3000 described above, a storage system 3900 may be used to control the storage of the hydrogen gas. The storage system 3900 comprises a tank 3902 large and strong enough to house the stack 3000 and to safely hold the hydrogen gas exiting the stack 3000. A valve system 3904 is fluidically engaged with the tank 3904. The hydrogen can be conveyed via the valve system 3904 to supply tanks or to high pressure ball tanks. At other times the valve system 3904 can be used to connect the tank 3904 to a vacuum pump, for removing air at the beginning of the hydrolysis process in the stack 3000.

Water and oxygen can exit the stack 3000 and the tank 3902 via pipe 3906a and reenter the stack 3000 and tank 3902 via pipe 3906b.

The gaseous hydrolysis products in the tank are essentially hydrogen, i.e., the expected purity of hydrogen in the gaseous hydrolysis products in the tank is at least 99.9% v/v, and depending upon the purity of the water fed to the stack and the leak-proofness of the systems, is expected to be at least 99.99%.

FIG. 14 illustrates yet another embodiment of a bipolar plate 4202 for a stack.

Gasket material is injected onto a bipolar plate in an over molding process. The bipolar plate 4202 includes small holes 4216 that allow the elastomer to pass from one side to the other during the injection process. This process and bipolar plate provide an improved sealing between each anode and cathode in a cell and between the cells of the stack.

### Example Stack

1. A stack with an active area diameter of 60 cm will provide a surface area of 2880 cm².
2. The current on the area for a standard of 2 amps/cm² will be 5760 amps (today the standard is 1 amps/cm²).
3. For a stack of 100 cells, 2 volts/cell (sufficient voltage for hydrolysis) requires supplying voltage of 200 volts/stack.
4. The power of the stack will be 200 volt×5760 amp=1.15 MW.
5. Thickness of a current collector and a bipolar plate will be about 1 mm.
6. The cell thickness will be about 5 mm; i.e., thickness of 100 cells will be about 500 mm.
7. The weight of 100 cells will be about 500 kilos.
8. The thickness of the end plates is about 200 mm each (the force acting on the plates at a pressure of 30 bar is 460 kilos).
9. The weight of two end plates will be about 920 kilos.
10. The total weight for a stack capable of a power of 1.1 MW will be about 1500 kilos.
11. The outer diameter of the stack (including screws) will be about 80 cm and its length about 0.9 meters.
12. To produce 1 kilo of hydrogen/hour, 50 KW is needed.
13. A 1.1 MW STACK can produce 22 kilos per hour=528 kilos/day=192720 kilos/year=9202119 m³/year.
14. Daily production of 528 kilos=193 m³/day at a pressure of 30 bar.
15. A Container with a diameter of 4 and a height of 15 meters=192 cubic meters (enough for storing daily production).

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

“About” is defined as ±25% of the stated value.

1-16. (canceled)

17. An electrolyzer comprising:
a stack of dome-shaped bipolar plates.

18. The electrolyzer of claim 17,
each plate comprising: a plate rim and a plurality of anode reaction outlets and cathode reaction outlets on the rim;
wherein:
the anode reaction outlets are aligned therethrough the stack and cathode reaction outlets are aligned therethrough the stack.

19. The electrolyzer of claim 17, each plate comprising a plate center, and reactant inlets extending throughout each center.

20. The electrolyzer of claim 18, each plate comprising a plate center, and reactant inlets extending throughout each center.

21. The electrolyzer of claim 17, wherein each plate has a thickness of from about 0.2 mm up to about 1 mm.

22. The electrolyzer of claim 17, further comprising at least one of a group consisting of: dome-shaped mesh, dome-shaped GDL, dome-shaped diaphragm or membrane (MEA), dome-shaped current collector, and dome-shaped end plates.

23. The electrolyzer of claim 18, further comprising at least one of a group consisting of: dome-shaped mesh, dome-shaped GDL, dome-shaped diaphragm or membrane (MEA), dome-shaped current collector, and dome-shaped end plates.

24. The electrolyzer of claim 19, further comprising at least one of a group consisting of: dome-shaped mesh, dome-shaped GDL, dome-shaped diaphragm or membrane (MEA), dome-shaped current collector, and dome-shaped end plates.

25. The electrolyzer of claim 17, each plate comprising a plurality of anode channels on an anode side of the plate and a plurality of cathode channels on a cathode side of the plate, wherein each anode channel overlaps a plurality of cathode channels and each cathode channel overlaps a plurality of anode channels.

26. The electrolyzer of claim 18, each plate comprising a plurality of anode channels on an anode side of the plate and a plurality of cathode channels on a cathode side of the plate, wherein each anode channel overlaps a plurality of cathode channels and each cathode channel overlaps a plurality of anode channels.

27. The electrolyzer of claim 19, each plate comprising a plurality of anode channels on an anode side of the plate and a plurality of cathode channels on a cathode side of the plate, wherein each anode channel overlaps a plurality of cathode channels and each cathode channel overlaps a plurality of anode channels.

28. The electrolyzer of claim 17, wherein each bipolar plate further comprises holes that allow elastomeric gasket material to pass from one side to the other of the plate during an injection over molding process performed on the plate.

29. The electrolyzer of claim 17, the stack further comprising end plates having a thickness from 20 mm to 200 mm.

30. The electrolyzer of claim 17, wherein the dome-shaped bipolar plates are produced by a process selected from one or more of: vacuum forming and stamping.

31. The electrolyzer of claim 30, further comprising a plurality of dome-shaped meshes produced by stamping, and/or,
dome-shaped GDLs produced by stamping.

32. The electrolyzer of claim 18, configured to allow:
holding up the stack;
feeding a liquid to the stack;
performing hydrolysis on the liquid fed to the stack;
allowing products of hydrolysis on the plate cathodic side and on the plate anodic side to be separated from each other and float in a continuum up the stack through the outlets.

33. The electrolyzer of claim 32, wherein the products of hydrolysis on the plate cathodic side are essentially hydrogen.

34. An electrolysis system comprising the electrolyzer of claim 25,
further comprising a storage system comprising a tank containing the stack, and the electrolysis system configured to allow:
feeding a liquid to the stack;
performing hydrolysis on the liquid fed to the stack;
allowing products of hydrolysis on the plate cathodic side and on the plate anodic side to be separated from each other; and
controlling storage of gaseous hydrolysis products in the tank from electrolysis in the stack.

35. The electrolysis system of claim 34, wherein the gaseous hydrolysis products in the tank are essentially hydrogen.

36. An electrolysis system comprising:
an electrolyzer comprising a stack of dome-shaped bipolar plates, and a storage system comprising a tank containing the stack, and configured to allow controlling storage of gaseous hydrolysis products from electrolysis in the stack.
